(19) United States
(12) Patent Application Publication
(10) Pub. No.: US 2013/0287878 A1
(43) Pub. Date: Oct. 31, 2013

(54) Molding System having Material Preparation and Delivery Systems and Material-Mixing Assembly

(71) Applicant: Dietmar Tiemo Brand, North York (CA)

(72) Inventor: Dietmar Tiemo Brand, North York (CA)

(73) Assignee: HUSKY INJECTION MOLDING SYSTEMS LTD., Bolton, ON (CA)

(21) Appl. No.: 13/997,679

(22) PCT Filed: Jan. 5, 2012
(86) PCT No.: PCT/CA2012/050001

§ 371 Date: Jun. 25, 2013

Related U.S. Application Data
(60) Provisional application No. 61/431,025, filed on Jan. 9, 2011.

(51) Int. Cl. B29C 45/18

(52) U.S. Cl. CPC B29C 45/18
USPC 425/145; 425/200

(57) ABSTRACT

A molding system (100), comprising: a collection (102) of material preparation and delivery systems (102A, 102B, 102C, 102D); and a material-mixing assembly (104) being in fluid communication with the collection (102) of material preparation and delivery systems (102A, 102B, 102C, 102D), the material-mixing assembly (104) being configured for fluid communication with a material-receiving assembly (106).

### TECHNICAL FIELD

An aspect generally relates to (but is not limited to) a molding system having: a collection of material preparation and delivery systems and a material-mixing assembly.

### SUMMARY

The inventor has researched a problem associated with known molding systems that inadvertently manufacture bad-quality molded articles or parts. After much study, the inventor believes he has arrived at an understanding of the problem and its solution, which are stated below, and the inventors believe this understanding is not known to the public.

According to one aspect, there is provided a molding system (100), comprising: a collection (102) of material preparation and delivery systems (102A, 102B, 102C, 102D); and a material-mixing assembly (104) being in fluid communication with the collection (102) of material preparation and delivery systems (102A, 102B, 102C, 102D), the material-mixing assembly (104) being configured for fluid communication with a material-receiving assembly (106).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

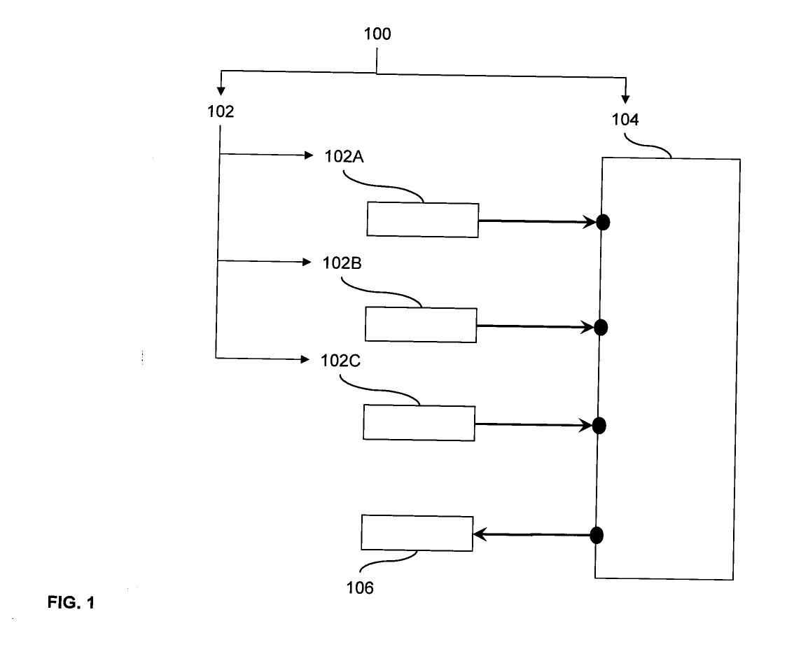

FIGS. 1 to 9 depict schematic representations of a molding system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1 to 9 depict schematic representations of a molding system (100). The molding system (100) may include components that are known to persons skilled in the art, and these known components will not be described here; these known components are described, at least in part, in the following reference books (for example): (i) “Infection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

Referring to FIG. 1, there is depicted an example of the molding system (100), which may include (and is not limited to): (i) a collection (102) of material preparation and delivery systems (102A, 102B, 102C, 102D), and (ii) a material-mixing assembly (104) that may be in fluid communication with the collection (102) of material preparation and delivery systems (102A, 102B, 102C, 102D). The material-mixing assembly (104) may be configured for fluid communication with a material-receiving assembly (106). The material that may be mixed by the material-mixing assembly (104) includes for example (and is not limited to): a melted resin, a liquid element, a flowable solid material, a gas component, etc, and any combination and permutation of the foregoing materials.

More specifically, the molding system (100) may be adapted such that (and is not limited to): the collection (102) of material preparation and delivery systems (102A, 102B, 102C, 102D) may be configured to prepare and to deliver, in use, a collective of materials to the material-mixing assembly (104). The collective of materials are materials that may be different from each other, such that at least two or more of the materials are different from each other. The material-mixing assembly (104) may be configured to mix, in use, the collective of materials that may be received from the collection (102) of material preparation and delivery systems (102A, 102B, 102C, 102D). The material-receiving assembly (106) may be configured to receive, in use, the collective of materials from the material-mixing assembly (104).

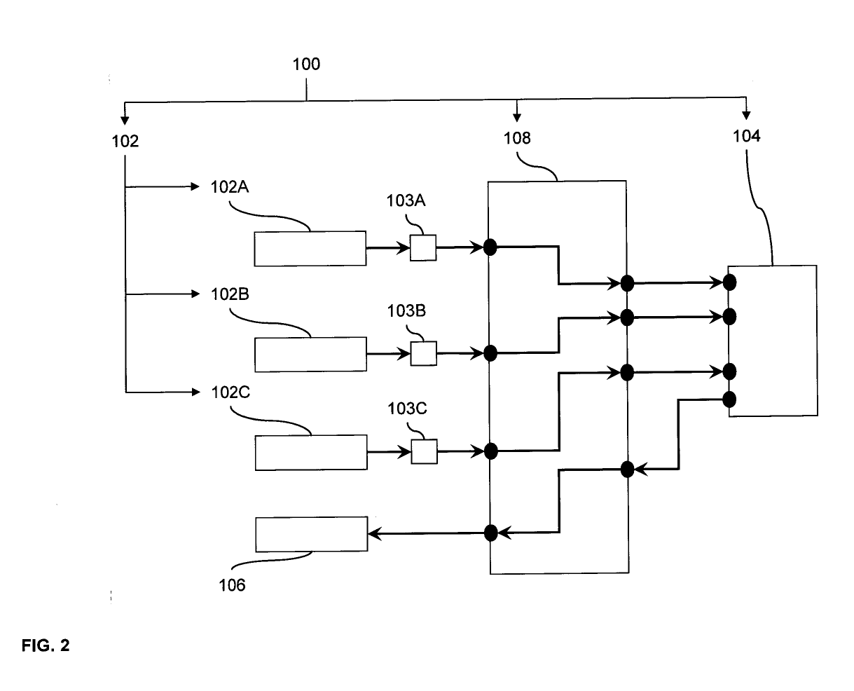

Referring to FIG. 2, there is depicted another example of the molding system (100), which may include (and is not limited to): a material-distribution assembly (108) that is configured to fluidly connect, in use, the material-mixing assembly (104) with the collection (102) of material preparation and delivery systems (102A, 102B, 102C, 102D). It will be appreciated that valve assemblies (103A, 1036, 103C) may be inserted between respective material preparation and delivery systems (102A, 102B, 102C, 102D) and the material-distribution assembly (108), and the valve assemblies (103A, 103B, 103C) are configured to prevent back flow of material to respective material preparation and delivery systems (102A, 102B, 102C, 102D). The valve assemblies (103A, 103B, 103C) may be integrated to the material-distribution assembly (108) if so required.

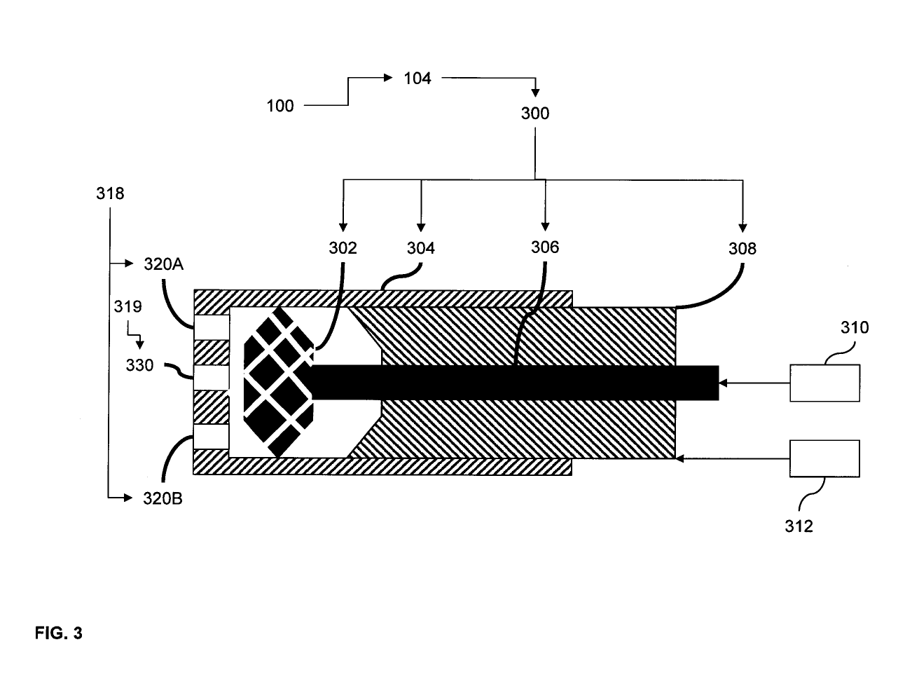

Referring to FIG. 3, there is depicted another example of the molding system (100), in which the material-mixing assembly (104) may include (and is not limited to): a shooting pot mixer assembly (300). The shooting pot mixer assembly (300) may include (and is not limited to): (i) a mixer assembly (302), (ii) a housing assembly (304), (iii) a piston assembly (308), (iv) a mixer actuator (310), and (v) a piston actuator assembly (312). The mixer assembly (302) may be configured to mix, in use, the collective of materials from the collection (102) of material preparation and delivery systems (102A, 102B, 102C, 102D). The housing assembly (304) may define an inner chamber that is configured (i) receive the mixer assembly (302), and (ii) to receive, in use, the collective of materials from the collection (102) of material preparation and delivery systems (102A, 102B, 102C, 102D). The housing assembly (304) may have (and is not limited to): (i) a material inlet assembly (318) (which may include for example and not limited to a plurality of material inlets (320A, 320B)) that may be configured for fluid connection with the collection (102) of material preparation and delivery systems (102A, 102B, 102C, 102D), and (ii) a material outlet assembly (319) (which may include for example and not limited to a material outlet (330)) that may be configured for fluid communication with the material-receiving assembly (106). The mixer connector (306) may be configured to connect with the mixer assembly (302). The piston assembly (308) may be received in the housing assembly (304). The piston assembly (308) may be configured to move (push and/or to rotate), in use, the collective of materials from the housing assembly (304). The piston assembly (308) and the mixer connector (306) may be coaxially arranged relative to each other. The mixer actuator (310) may be configured to connect with the mixer connector (306). The mixer actuator (310) may be configured to rotate and to translate, in use, the mixer connector (306) in response to the mixer actuator (310) receiving, in use, a control command from a controller. The piston actuator assembly (312) may be connected with the piston assembly (308). The piston actuator assembly (312) may be configured to translate, in use, the piston assembly (308) in response to the piston actuator assembly (312) receiving, in use, a controlling command from the controller.

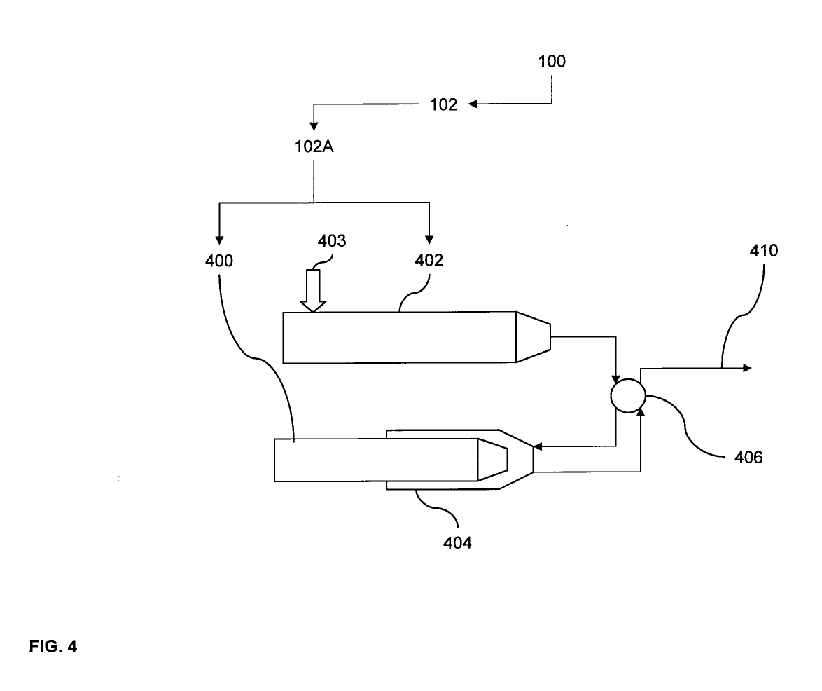

Referring to FIG. 4, there is depicted another example of the molding system (100), in which the collection (102) of material preparation and delivery systems (102A, 102B, 102C, 102D) may include (and is not limited to): a material preparation and delivery system (102A) of a specific type. For example, the material preparation and delivery system (102A) may include (and is not limited to): (i) a shooting pot piston assembly (400), (ii) an extruder assembly (402), (iii) a shooting pot cylinder assembly (404), and (iv) a distributor (406). The shooting pot piston assembly (400) may be configured to eject a material (such as a melt for example). The extruder assembly (402) may have an input assembly (403) that may be configured to receive, in use, a solid polymer material. The shooting pot cylinder assembly (404) may be configured to receive the shooting pot piston assembly (400). The distributor (406) may be in fluid communication with: (i) an outlet of the extruder assembly (402), and (ii) the shooting pot cylinder assembly (404). The distributor (406) may have an output (410) that may be configured to fluidly communicate with the material-mixing assembly (104).

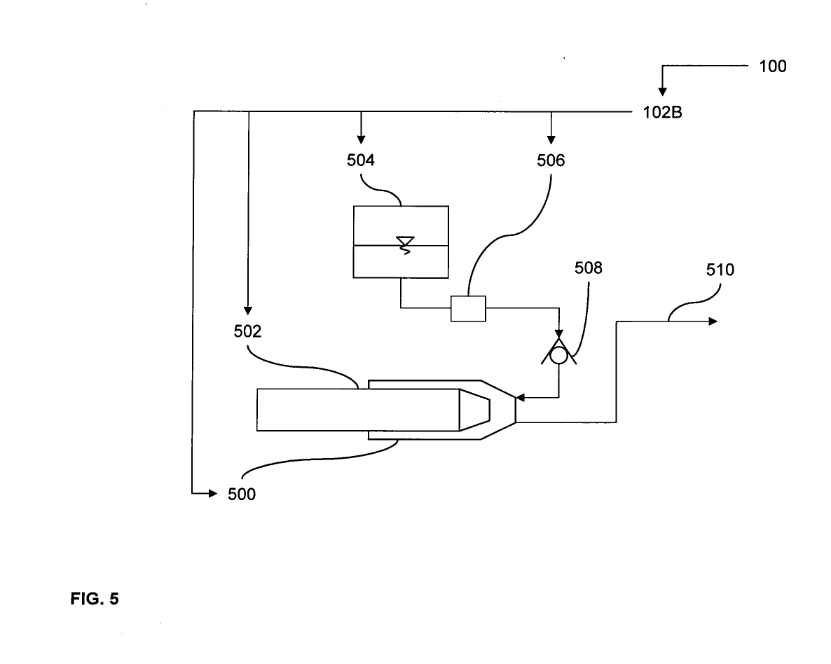

Referring to FIG. 5, there is depicted another example of the molding system (100), in which the collection (102) of material preparation and delivery systems (102A, 102B, 102C, 102D) may include (and is not limited to): a material preparation and delivery system (102B) of a specific type. For example, the material preparation and delivery system (102B) may have (and is not limited to): (i) a metering cylinder assembly (500), (ii) a metering piston assembly (502), (iii) a liquid ingredient delivery unit (504), (iv) a pump assembly (506), and (v) a check valve assembly (508). The metering cylinder assembly (500) may have an output (510) that may be configured for fluid communication with the material-mixing assembly (104). The metering piston assembly (502) may be received in the metering cylinder assembly (500). The liquid ingredient delivery unit (504) may be configured to receive, in use, a moldable liquid material. The pump assembly (506) may be in fluid communication with the liquid ingredient delivery unit (504). The check valve assembly (508) may be in fluid communication with the pump assembly (506) and with the metering cylinder assembly (500). The metering cylinder assembly (500) and the metering piston assembly (502) may be configured to process, in use, the moldable liquid material. The pump assembly (506) may be configured to pump, in use, the moldable liquid material to the metering cylinder assembly (500) through the check valve assembly (508). The check valve assembly (508) may be configured to prevent back flow, in use, of the moldable liquid material toward the liquid ingredient delivery unit (504).

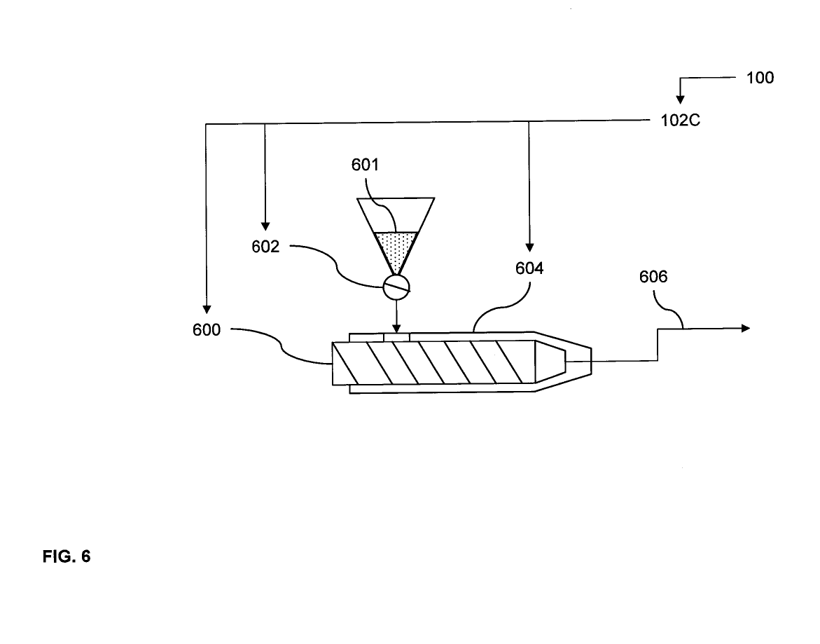

Referring to FIG. 6, there is depicted another example of the molding system (100), in which the collection (102) of material preparation and delivery systems (102A, 102B, 102C, 102D) may include (and is not limited to): a material preparation and delivery system (102C) of a specific type. For example, the material preparation and delivery system (102C) may have (and is not limited to): (i) a metering screw assembly (600), (ii) a gravimetric dispenser assembly (602), and (iii) a metering housing assembly (604). The gravimetric dispenser assembly (602) may be configured to dispense, in use, a solid ingredient (601) to the metering screw assembly (600). The metering housing assembly (604) may be configured to receive and to house the metering screw assembly (600). The metering housing assembly (604) may have an output (606) that may be configured for fluid communication with the material-mixing assembly (104).

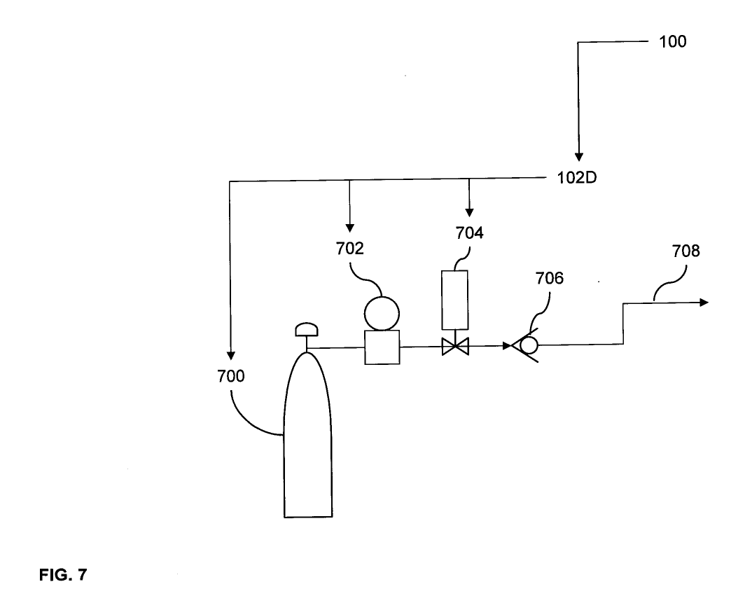

Referring to FIG. 7, there is depicted another example of the molding system (100), in which the collection (102) of material preparation and delivery systems (102A, 102B, 102C, 102D) may include (and is not limited to): a material preparation and delivery system (102D) of a specific type. For example, the material preparation and delivery system (102D) may have (and is not limited to): (i) a gas supply assembly (700), (ii) a pressure regulator assembly (702), (iii) a gas flow controller assembly (704), and (iv) a check valve assembly (706). The gas supply assembly (700) may be configured to provide a gas medium. The pressure regulator assembly (702) may be in fluid communication with the gas supply assembly (700). The pressure regulator assembly (702) may be configured to regulate, in use, a pressure of the gas medium leaving the gas supply assembly (700). The gas flow controller assembly (704) may be in fluid communication with the pressure regulator assembly (702). The gas flow controller assembly (704) may be configured to control an amount of the gas medium leaving the pressure regulator assembly (702). The check valve assembly (706) may be in fluid communication with the gas flow controller assembly (704). The check valve assembly (706) may be configured to prevent a backflow of the gas medium toward the gas supply assembly (700). The check valve assembly (706) may have an output (708) that may be configured for fluid communication with the material-mixing assembly (104).

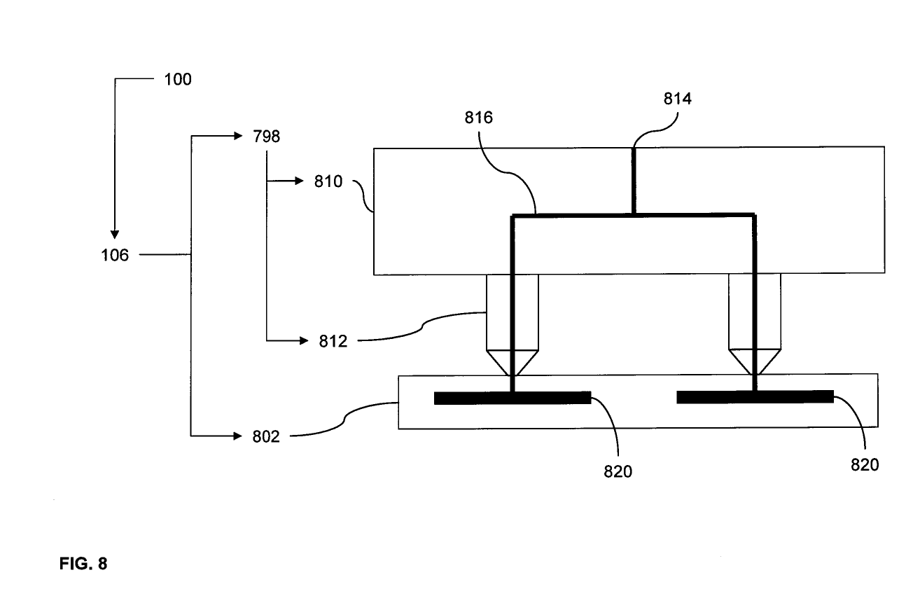

Referring to FIG. 8, there is depicted another example of the molding system (100), in which the material-receiving assembly (106) may include (and is not limited to): (i) a runner assembly (800), and (ii) a mold assembly (802) that may be configured, in use, for fluid communication with the runner assembly (800). The mold assembly (802) may include for example (and not limited to: a compression mold assembly or an injection mold assembly, etc. The runner assembly (800) may include for example and not limited to: a hot runner assembly or a cold runner assembly. The runner assembly (800) may have (for example and not limited to): (i) a manifold assembly (810), and (ii) a nozzle assembly (812). The manifold assembly (810) may have an input (814) that may be configured to be in fluid communication with the material-mixing assembly (104). The manifold assembly (810) may provide a material distribution flow path (816) connecting the input (814) to the nozzle assembly (812). The nozzle assembly (812) may be configured to convey, in use, a material (such as a melt for example) to the mold assembly (802). The mold assembly (802) may be configured to form, in use, a molded article (820).

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A molding system (100), comprising:
a collection (102) of material preparation and delivery systems (102A, 102B, 102C, 102D); and
a material-mixing assembly (104) being in fluid communication with the collection (102) of material preparation and delivery systems (102A, 102B, 102C, 102D), the material-mixing assembly (104) being configured for fluid communication with a material-receiving assembly (106).

2. The molding system of claim 1, wherein:
the collection (102) of material preparation and delivery systems (102A, 102B, 102C, 102D) being configured to prepare and to deliver, in use, a collective of materials to the material-mixing assembly (104),
the material-mixing assembly (104) being configured to mix, in use, the collective of materials being received from the collection (102) of material preparation and delivery systems (102A, 102B, 102C, 102D), and
the material-receiving assembly (106) being configured to receive, in use, the collective of materials from the material-mixing assembly (104).

3. The molding system of claim 1, further comprising:
a material-distribution assembly (108) being configured to fluidly connect, in use, the material-mixing assembly (104) with the collection (102) of material preparation and delivery systems (102A, 102B, 102C, 102D).

4. The molding system of claim 1, further comprising:
the material-mixing assembly (104) includes:
a shooting pot mixer assembly (300), having:
a mixer assembly (302) being configured to mix, in use, a collective of materials from the collection (102) of material preparation and delivery systems (102A, 102B, 102C, 102D);
a housing assembly (304) defining an inner chamber being configured (i) receive the mixer assembly (302), and (ii) to receive, in use, the collective of materials from the collection (102) of material preparation and delivery systems (102A, 102B, 102C, 102D), the housing assembly (304) having:
a material inlet assembly (318) being configured for fluid connection with the collection (102) of material preparation and delivery systems (102A, 102B, 102C, 102D); and
a material outlet assembly (319) being configured for fluid communication with the material-receiving assembly (106);
a mixer connector (306) being configured to connect with the mixer assembly (302);
a piston assembly (308) being received in the housing assembly (304), the piston assembly (308) being configured to move, in use, the collective of materials from the housing assembly (304), and the piston assembly (308) and the mixer connector (306) being coaxially arranged relative to each other;
a mixer actuator (310) being configured to connect with the mixer connector (306), the mixer actuator (310) being configured to rotate and to translate, in use, the mixer connector (306) in response to the mixer actuator (310) receiving, in use, a control command from a controller; and
a piston actuator assembly (312) being connected with the piston assembly (308), the piston actuator assembly (312) being configured to, in use, translate the piston assembly (308) in response to the piston actuator assembly (312) receiving, in use, a controlling command from the controller.

5. The molding system of claim 1, wherein:
the collection (102) of material preparation and delivery systems (102A, 102B, 102C, 102D) includes:
a material preparation and delivery system (102A) includes:
a shooting pot piston assembly (400) being configured to eject a material;
an extruder assembly (402) having an input assembly (403) being configured to receive, in use, a solid polymer material;
a shooting pot cylinder assembly (404) being configured to receive the shooting pot piston assembly (400);
a distributor (406) being in fluid communication with: (i) an outlet of the extruder assembly (402), and (ii) the shooting pot cylinder assembly (404), the distributor (406) having an output (410) being configured to fluidly communicate with the material-mixing assembly (104).

6. The molding system of claim 1, wherein:
the collection (102) of material preparation and delivery systems (102A, 102B, 102C, 102D) includes:
a material preparation and delivery system (102B), having:
a metering cylinder assembly (500) having an output (510) being configured for fluid communication with the material-mixing assembly (104);
a metering piston assembly (502) being received in the metering cylinder assembly (500);
a liquid ingredient delivery unit (504) being configured to receive, in use, a moldable liquid material;
a pump assembly (506) being in fluid communication with the liquid ingredient delivery unit (504); and
a check valve assembly (508) being in fluid communication with the pump assembly (506) and with the metering cylinder assembly (500),
the metering cylinder assembly (500) and the metering piston assembly (502) being configured to process, in use, the moldable liquid material;
the pump assembly (506) being configured to pump, in use, the moldable liquid material to the metering cylinder assembly (500) through the check valve assembly (508), and
the check valve assembly (508) being configured to prevent back flow, in use, of the moldable liquid material toward the liquid ingredient delivery unit (504).

7. The molding system of claim 1, wherein:
the collection (102) of material preparation and delivery systems (102A, 102B, 102C, 102D) includes:
a material preparation and delivery system (102C), having:
a metering screw assembly (600);
a gravimetric dispenser assembly (602) being configured to dispense, in use, a solid ingredient (601) to the metering screw assembly (600);
a metering housing assembly (604) being configured to receive and to house the metering screw assembly (600), the metering housing assembly (604) having an output (606) being configured for fluid communication with the material-mixing assembly (104).

8. The molding system of claim 1, wherein:
the collection (102) of material preparation and delivery systems (102A, 102B, 102C, 102D) includes:
a material preparation and delivery system (102D), having:
a gas supply assembly (700) being configured to provide a gas medium;
a pressure regulator assembly (702) being in fluid communication with the gas supply assembly (700), the pressure regulator assembly (702) being configured to regulate, in use, a pressure of the gas medium leaving the gas supply assembly (700);
a gas flow controller assembly (704) being in fluid communication with the pressure regulator assembly (702), the gas flow controller assembly (704) being configured to control an amount of the gas medium leaving the pressure regulator assembly (702); and
a check valve assembly (706) being in fluid communication with the gas flow controller assembly (704), the check valve assembly (706) being configured to prevent a backflow of the gas medium toward the gas supply assembly (700), and the check valve assembly (706) having an output (708) being configured for fluid communication with the material-mixing assembly (104).

9. The molding system of claim 1, wherein:
the material-receiving assembly (106) includes:
a runner assembly (800); and
a mold assembly (802) being configured, in use, for fluid communication with the runner assembly (800).
